(19) United States
(12) Patent Application Publication
(10) Pub. No.: US 2011/0272634 A1
(43) Pub. Date: Nov. 10, 2011

(54) CERIUM AND/OR TERBIUM PHOSPHATE OPTIONALLY WITH LANTHANUM, PHOSPHOR RESULTING FROM SAID PHOSPHATE AND METHODS FOR MAKING SAME

(75) Inventors: Valérie Buissette, Paris (FR); Thierry Le-Mercier, Rosny-sous-Bois (FR)

(73) Assignee: RHODIA OPERATIONS, Aubervilliers (FR)

(21) Appl. No.: 13/129,704

(22) PCT Filed: Nov. 18, 2009
(86) PCT No.: PCT/EP2009/065395

§ 371 Date: Jul. 28, 2011

(30) Foreign Application Priority Data
Nov. 20, 2008 (FR) FR 08/06505

(51) Int. Cl. C09K 11/81; C01F 17/00

(52) U.S. Cl. 252/301.4 P; 423/263

(57) ABSTRACT

A rare earth element phosphate (Ln) is described, wherein Ln is either: (1) at least one rare earth element selected from cerium and terbium, or (2) lanthanum in combination with at least one of the above two rare earth elements, and wherein the phosphate has a crystalline structure either of the rhabdophane type with a sodium content of at most 6000 ppm, or of the monazite type with a sodium content of at most 4000 ppm. The phosphate can be obtained by the precipitation of a rare earth element chloride at a constant pH lower than 2, and then calcining and redispersing the same in hot water. A phosphor obtained by calcining the phosphate at at least 1000° C. is also described.

The present invention relates to a phosphate of cerium and/or terbium, optionally with lanthanum, to a phosphor resulting from this phosphate and also to methods for preparing same.

Mixed phosphates of lanthanum, terbium and cerium and mixed phosphates of lanthanum and terbium, hereinafter generally denoted LAPs, are well known for their luminescence properties. For example, when they contain cerium and terbium, they emit a bright green light when they are irradiated by certain high-energy radiation having wavelengths below those of the visible range (UV or VUV radiation for lighting or displaying systems). Phosphors that exploit this property are commonly used on an industrial scale, for example in trichromatic fluorescent lamps, in backlighting systems for liquid crystal displays or in plasma systems.

Several methods for preparing LAPs are known. These methods are of two types. Firstly, there are “dry” methods where phosphatation of a mixture of oxides or of a mixed oxide is carried out in the presence of diammonium phosphate. These methods, which can possibly be relatively long and complicated, especially pose a problem for controlling the size and the chemical homogeneity of the products obtained. The other type of methods group together those termed “wet methods”, where a synthesis, in liquid medium, of a mixed phosphate of rare-earth metals or of a mixture of phosphates of rare-earth metals is carried out.

These various syntheses result in mixed phosphates that require, for their application in luminescence, a heat treatment at a high temperature, approximately 1100° C., under a reducing atmosphere, generally in the presence of a fluxing agent or flux. This is because, in order for the mixed phosphate to be the most effective phosphor possible, it is necessary for the terbium and, where appropriate, the cerium to be as far as possible in the 3+ oxidation state.

The abovementioned dry and wet methods have the drawback of resulting in phosphors of uncontrolled, especially insufficiently narrow, particle size which is further accentuated by the necessity of the high-temperature thermal activation treatment, with flux and under a reducing atmosphere, which generally causes further disturbances in the particle size, thus resulting in phosphor particles which are not homogeneous in size, which may in addition contain greater or smaller amounts of impurities linked in particular to the use of the flux, and which in the end exhibit insufficient luminescence performance.

A method has been proposed in patent application EP 0581621 that makes it possible to improve the particle size of the LAPs, with a narrow particle size distribution, which results in particularly high-performance phosphors. The method described uses more particularly nitrates as rare-earth metal salts and recommends the use of aqueous ammonia as base, which has the drawback of a discharge of nitrogenous products. Consequently, while the method indeed results in high-performance products, the implementation thereof may be made more complicated if it is to comply with increasingly restrictive ecological legislations which prohibit or limit such discharges.

It is admittedly possible to use in particular strong bases other than aqueous ammonia, for instance alkali metal hydroxides, but the latter create the presence of alkalis in the LAPS and this presence is considered to be capable of degrading the luminescence properties of the phosphors during their use, in particular in mercury vapor lamps.

There is therefore currently a need for preparation methods using little or no nitrates or aqueous ammonia, or even not requiring the use of flux during the preparation of the phosphors, this being without negative consequences on the luminescence properties of the products obtained.

A subject of the invention is the development of a method for preparing LAPS which limits the discharge of nitrogenous products, or even has no discharge of these products.

Another subject of the invention is the provision of phosphors which nevertheless have the same properties as those of the phosphors currently known, or even superior properties.

To this effect, according to a first aspect, the invention provides a rare-earth metal (Ln) phosphate, Ln representing either at least one rare-earth metal selected from cerium and terbium, or lanthanum in combination with at least one of the abovementioned two rare-earth metals, characterized in that it has a crystalline structure, either of rhabdophane type or of mixed rhabdophane/monazite type, and in that it contains sodium, the sodium content being 6000 ppm at most.

The invention also relates to a rare-earth metal (Ln) phosphate, Ln having the same meaning as above, which is characterized in that it has a crystalline structure of monazite type and in that it contains sodium, the sodium content being 4000 ppm at most.

According to another aspect, the invention also relates to a phosphor based on a rare-earth metal (Ln) phosphate, Ln having the same meaning as above, which is characterized in that it has a crystalline structure of monazite type and in that it contains sodium, the sodium content being 350 ppm at most.

The phosphors of the invention, despite the presence of an alkali metal, sodium, have good luminescence properties and a good lifespan. They can even exhibit a better luminescence yield than the known products.

Other features, details and advantages of the invention will become even clearer on reading the description which follows, and also the various concrete but nonlimiting examples intended to illustrate it.

It is also specified, for the rest of the description, that, unless otherwise indicated, in all the ranges or limits of values which are given, the values at the limits are included, the ranges or limits of values thus defined therefore covering any value which is at least equal to or greater than the lower limit and/or at most equal to or less than the upper limit.

With regard to the sodium contents mentioned in the rest of the description for the phosphates and the phosphors, it will be noted that minimum values and maximum values are given. It should be understood that the invention covers any range of sodium content defined by any one of these minimum values with any one of these maximum values.

The term “rare-earth metal” is intended to mean, for the rest of the description, the elements of the group made up of yttrium and the elements of the periodic table having an atomic number of between 57 and 71, inclusive.

It is also specified here and for the entire description that the sodium content is measured according to two techniques. The first is the X-ray fluorescence technique, and it makes it possible to measure sodium contents which are at least approximately 100 ppm. This technique will be used more particularly for the phosphates or precursors or the phosphors for which the sodium contents are the highest. The second technique is the ICP (inductively coupled plasma)—AES (atomic emission spectroscopy) or ICP-OES (optical emission spectroscopy) technique. This technique will more particularly be used here for the precursors or the phosphors for which the sodium contents are the lowest, in particular for contents of less than approximately 100 ppm.

As has been seen above, the invention relates to two types of products: phosphates, also subsequently referred to as precursors, and phosphors obtained from these precursors. The phosphors themselves have luminescence properties that are sufficient to make them directly usable in the desired applications. The precursors do not have luminescence properties or, optionally, have luminescence properties that are too weak for use in these same applications.

These two types of products will now be described more precisely.

### The Phosphates or Precursors

The phosphates of the invention are provided according to two embodiments which differ from one another by virtue of the crystallographic structure of the products. The features common to these two embodiments will first of all be described.

The phosphates of the invention are essentially, the presence of other residual phosphated entities in fact being possible, and preferably, completely of orthophosphate type of formula LnPO₄, Ln being as defined above.

The phosphates of the invention are phosphates of cerium or terbium or else of a combination of these two rare-earth metals. They can also be phosphates of lanthanum in combination with at least one of these abovementioned two rare-earth metals, and they can also most particularly be phosphates of lanthanum, cerium and terbium.

The respective proportions of these various rare-earth metals can vary within broad limits, and more particularly within the ranges of values that will be given below. Thus, the phosphates of the invention essentially comprise a product which can correspond to the following general formula (1):

LaₓCe_{y}Tb_{z}PO₄ (1)

in which the sum x+y+z is equal to 1 and at least one of y and of z is other than 0.

In formula (1) above, x can be more particularly between 0.2 and 0.98, and even more particularly between 0.4 and 0.95.

The presence of the other residual phosphated entities mentioned above can cause the Ln (the rare-earth metals as a whole)/PO₄ molar ratio to possibly be less than 1 for the phosphate as a whole.

If at least one of x and of y is other than 0 in formula (1), preferably z is at most 0.5 and z can be between 0.05 and 0.2 and more particularly between 0.1 and 0.2.

If y and z are both other than 0, x can be between 0.2 and 0.7 and more particularly between 0.3 and 0.6.

If z is equal to 0, y can be more particularly between 0.02 and 0.5 and even more particularly between 0.05 and 0.25.

If y is equal to 0, z can be more particularly between 0.05 and 0.6 and even more particularly between 0.08 and 0.3.

If x is equal to 0, z can be more particularly between 0.1 and 0.4.

Merely by way of examples, mention may be made of the following more particular compositions:

La_{0.44}Ce_{0.43}Tb_{0.13}PO₄

La_{0.57}Ce_{0.29}Tb_{0.14}PO₄

La_{0.94}Ce_{0.06}PO₄

Ce_{0.67}Tb_{0.33}PO₄

The phosphate of the invention can comprise other elements which conventionally play the role in particular of a promoter of the luminescence properties or of a stabilizer of the degrees of oxidation of the elements cerium and terbium. By way of example of these elements, mention may more particularly be made of boron and other rare-earth metals such as scandium, yttrium, lutecium and gadolinium. When lanthanum is present, the abovementioned rare-earth metals may be more particularly present as a replacement for this element. These promoter or stabilizer elements are present in an amount generally of at most 1% by mass of element relative to the total mass of the phosphate of the invention, in the case of boron, and generally of at most 30% for the other elements mentioned above.

The phosphates of the invention are also characterized by their particle size.

They in fact consist of particles generally having a mean size of between 1 μm and 15 μm, more particularly between 2 μm and 6 μm.

The mean diameter to which reference is made is the mean by volume of the diameters of a population of particles.

The particle size values given here and for the rest of the description are measured by means of a Malvern laser particle sizer on a sample of particles dispersed in water by ultrasound (130 W) for 1 minute 30 seconds.

Moreover, the particles preferably have a low dispersion index, typically of at most 0.5 and preferably of at most 0.4.

The “dispersion index” of a population of particles is intended to mean, for the purposes of the present description, the ratio I as defined below:

I=(φ₈₄−φ₁₆)/(2×φ₅₀)
where: φ₈₄ is the diameter of the particles for which 84% of the particles have a diameter of less than φ₈₄;
φ₁₆ is the diameter of the particles for which 16% of the particles have a diameter of less than φ₁₆; and
φ₅₀ is the mean diameter of the particles, the diameter for which 50% of the particles have a diameter of less than φ₅₀.

This definition of the dispersion index given here for the particles of the precursors also applies, for the rest of the description, to the phosphors.

An important feature of the phosphates of the invention and which is common to the two embodiments is the presence of sodium. The amount of sodium depends on the embodiment. It may be supposed that the sodium is not present in the phosphate simply as a mixture with the other constituents thereof, but that it is chemically bonded with one or more constituent chemical elements of the phosphate.

According to one particular embodiment, the phosphates contain only sodium as alkali metal.

The two embodiments of the phosphates of the invention have, moreover, more specific features which will be described below.

For the first embodiment of the invention, the phosphate has a crystalline structure of rhabdophane type or of mixed rhabdophane/monazite type.

The crystalline structures to which reference is made here and in the rest of the description can be demonstrated by the X-ray diffraction (XRD) technique.

The phosphates can thus have a structure of rhabdophane type and they may, in this case, be phase pure, i.e. the XRD diagrams reveal just a one and only rhabdophane phase. Nevertheless, the phosphates of the invention may also not be phase pure, and in this case, the XRD diagrams of the products show the presence of very minor residual phases.

The phosphates may also have a structure of mixed rhabdophane/monazite type.

The rhabdophane or mixed rhabdophane/monazite structure corresponds to the phosphates which have either not undergone a heat treatment at the end of their preparation or have undergone a heat treatment at a temperature not exceeding generally below 600° C., in particular between 400° C. and 500° C.

The sodium content of the phosphate according to this first. embodiment is 6000 ppm at most, more particularly 5000 ppm at most. This content is expressed, here and for the whole of the description, by mass of sodium element relative to the total mass of the phosphate.

The minimum sodium content is not essential. It can correspond to the minimum value detectable by the analysis technique used to measure the sodium content. However, this minimum sodium content is generally at least 300 ppm, more particularly at least 1200 ppm.

The phosphate of crystalline structure of rhabdophane type consists of particles which themselves consist of an aggregation of crystallites of which the size, measured in the plane (012), is at least 35 nm. This size can also vary according to the temperature of the heat treatment or the calcination undergone by the precursor during its preparation.

It is specified here and for all of the description that the value measured by XRD corresponds to the size of the coherent domain calculated from the width of the main diffraction line corresponding to the crystallographic plane (012). The Scherrer model, as described in the book Théorie et technique de la radiocristallographie [Radiocrystallography theory and technique], A. Guinier, Dunod, Paris, 1956, is used for this measurement.

It should be noted that the description which has just been given regarding the size of the crystallites applies essentially to the case of the phosphates of rhabdophane structure since the determination of this size by the XRD technique becomes much more difficult in the case of a structure of mixed rhabdophane/monazite type.

This crystallite size, which is bigger than those of prior art phosphates obtained after a heat treatment at the same temperature and which can also have the same particle size, reflects a better crystallization of the products.

The phosphates of the first embodiment which have not undergone heat treatment are generally hydrated; however, simple drying, carried out, for example, between 60 and 100° C., is sufficient to eliminate most of this residual water and to result in substantially anhydrous rare-earth metal phosphates, the remaining minor amounts of water being, for their part, eliminated by calcinations carried out at higher temperatures, above approximately 400° C.

For the second embodiment, the phosphates have a crystalline structure of monazite type, which corresponds to products which are obtained after a heat treatment which is more severe than in the case of the phosphates of the first embodiment and which is carried out at a temperature of at least 600° C., advantageously between 700 and 1000° C.

As for the preceding embodiment, the phosphates may, in this case, be phase pure, i.e. the XRD diagrams reveal just a one and only monazite phase. Nevertheless, the phosphates of the invention may also not be phase pure, and in this case, the XRD diagrams of the products show the presence of very minor residual phases.

The sodium content of the phosphate according to this second embodiment is 4000 ppm at most, more particularly 3000 ppm at most.

As for the first embodiment, the minimum sodium content is not essential and it can correspond to the minimum value detectable by the analysis technique used to measure the sodium content. However, this minimum sodium content is generally at least 300 ppm, more particularly at least 1200 ppm.

The phosphates of monazite crystalline structure consist of particles which themselves consist of an aggregation of crystallites of which the size, measured in the plane (012), is at least 40 nm, more particularly at least 80 nm and even more particularly at least 100 nm, this size also varying according to the temperature of calcination undergone by the precursor during its preparation. Here again, the same observation as previously can be made here with regard to the better crystallization of the phosphates of the invention compared with the prior art phosphates having the same structure.

Although the phosphates or precursors according to the invention have, for those having undergone calcination or a heat treatment at a temperature generally above 600° C., and advantageously between 800 and 900° C., luminescence properties at wavelengths that are variable according to the composition of the product and after exposure to a ray of given wavelength (for example emission at a wavelength of approximately 550 nm, i.e. in the green range after exposure to a ray of wavelength of 254 nm for the phosphates of lanthanum, cerium and terbium), it is possible and even necessary to further improve these luminescence properties by carrying out post-treatments on the products, in order to obtain a real phosphor that is directly usable as such in the desired application.

It is understood that the border between a simple rare-earth metal phosphate and a real phosphor remains arbitrary, and depends only on the threshold of luminescence from which it is considered that a product can be directly used in an acceptable manner by a user.

In the present case, and quite generally, it is possible to consider and identify as phosphor precursors, rare-earth metal phosphates according to the invention which have not been subjected to heat treatments above approximately 900° C., since such products generally have luminescence properties that can be deemed not to meet the minimum requirement of brightness of the commercial phosphors that can be used directly as such, without any subsequent transformation. Conversely, it is possible to describe as phosphors the rare-earth metal phosphates which, optionally after having been subjected to appropriate treatments, develop suitable brightnesses that are sufficient to be used directly by an applicator, for example in lamps or television screens.

The description of the phosphors according to the invention will be given below.

### The Phosphors

The phosphors of the invention have characteristics in common with the phosphates or precursors which have just been described.

Thus, they have the same particle size characteristics as said phosphates or precursors, i.e. a mean particle size of between 1 and 15 μm with a dispersion index of at most 0.5. Everything which has been described above regarding the particle size for the precursors applies likewise here.

They also have, in an orthophosphate form of the same formula as that given above, a composition substantially identical to that of the precursors. The relative proportions of lanthanum, cerium and terbium which were given above for the precursors also apply here. Likewise, they can comprise the promoter or stabilizer elements which were mentioned above for the phosphates, and in the proportions indicated.

The phosphors have a crystalline structure of monazite type. According to one preferred embodiment, the phosphors of the invention are phase-pure, i.e. the XRD diagrams reveal only the one and only monazite phase. Nevertheless, the phosphors of the invention may also not be phase-pure, and in this case, the XRD diagrams of the products show the presence of very minor residual phases.

The phosphors of the invention contain sodium in an amount of 350 ppm at most, more particularly of 250 ppm at most and even more particularly of 100 ppm at most. This content is expressed, here also, as mass of sodium element relative to the total mass of the phosphor.

The minimum sodium content is not essential. Here also, as for the phosphates, it can correspond to the minimum value detectable by the analysis technique used to measure the sodium content. However, this content is generally at least 10 ppm and more particularly at least 50 ppm.

According to one particular embodiment, the phosphors do not contain any element other than sodium as alkali metal element.

The phosphors of the invention consist of particles of which the coherence length, measured in the plane (012), is at least 250 nm. This length, which is measured by the same technique as for the precursors, can vary according to the temperature of the heat treatment or of the calcination undergone by the phosphor during its preparation.

This coherence length may be at least 290 nm.

As for the precursors, it is also observed here that this coherence length is greater than those of the prior art phosphors obtained after a heat treatment at the same temperature and which can also have the same particle size. This reflects, here again, a better crystallization of the products, which is beneficial to their luminescence property, in particular for the luminescence yield.

The particles constituting the phosphors of the invention can have a substantially spherical shape. These particles are dense.

The methods for preparing the precursors and the phosphors of the invention will now be described.

### Methods for Preparing the Phosphates or Precursors

The first method which will be described concerns the preparation of the precursors according to the first embodiment, i.e. those with a crystalline structure either of rhabdophane type or of mixed rhabdophane/monazite type.

This method is characterized in that it comprises the following steps:
a first solution containing rare-earth metal (Ln) chlorides is continuously introduced into a second solution containing phosphate ions and having an initial pH of less than 2;
during the introduction of the first solution into the second, the pH of the resulting medium is controlled at a constant value of less than 2, by virtue of which a precipitate is obtained, wherein the placing of the second solution at a pH of less than 2 for the first step or the controlling of the pH for the second step, or both, are carried out at least partly with sodium hydroxide;
the resulting precipitate is recovered and, optionally, it is calcined at a temperature below 600° C.;
the product obtained is redispersed in hot water and is then separated from the liquid medium.

The various steps of the method will now be described in detail.

According to the invention, a direct precipitation, at a controlled pH, of a rare-earth metal (Ln) phosphate is carried out by reacting a first solution containing chlorides of one or more rare-earth metals (Ln), these elements then being present in the proportions required for obtaining the product of desired composition, with a second solution containing phosphate ions.

According to a first important characteristic of the method, a definite order of introduction of the reactants should be adhered to, and even more specifically, the solution of chlorides of the rare-earth metal(s) should be introduced, gradually and continuously, into the solution containing the phosphate ions.

According to a second important characteristic of the method according to the invention, the initial pH of the solution containing the phosphate ions should be less than 2, preferably between 1 and 2.

According to a third characteristic, the pH of the precipitation medium should then be controlled at a pH value of less than 2, and preferably between 1 and 2.

The term “controlled pH” is intended to mean maintaining of the pH of the precipitation medium at a certain, constant or substantially constant, value by addition of a basic compound to the solution containing the phosphate ions, simultaneously with the introduction into the latter of the solution containing the rare-earth metal chlorides. The pH of the medium will thus vary by at most 0.5 pH unit around the fixed setpoint value, and more preferably by at most 0.1 pH unit around this value. The fixed setpoint value will advantageously correspond to the initial pH (less than 2) of the solution containing the phosphate ions.

The precipitation is preferably carried out in an aqueous medium at a temperature which is not critical and which is advantageously between ambient temperature (15° C.-25° C.) and 100° C. This precipitation is carried out with stirring of the reaction medium.

The concentrations of the rare-earth metal chlorides in the first solution can vary within wide limits. Thus, the total concentration of rare-earth metals can be between 0.01 mol/liter and 3 mol/liter.

Finally, it will be noted that the solution of rare-earth metal chlorides can also comprise other metal salts, in particular chlorides, for instance salts of the promoter or stabilizer elements described above, i.e. of boron and of other rare-earth metals.

The phosphate ions intended to react with the solution of rare-earth metal chlorides can be provided by pure compounds or compounds in solution, for instance phosphoric acid, alkali metal phosphates or phosphates of other metal elements giving, with the anions associated with the rare-earth metals, a soluble compound.

The phosphate ions are present in an amount such that there is, between the two solutions, a PO₄/Ln molar ratio of greater than 1, and advantageously between 1.1 and 3.

As emphasized above in the description, the solution containing the phosphate ions should initially (i.e. before the beginning of the introduction of the solution of rare-earth metal chlorides) have a pH of less than 2, and preferably between 1 and 2. Thus, if the solution used does not naturally have such a pH, the latter is brought to the desired suitable value either by adding a basic compound or by adding an acid (for example, hydrochloric acid, in the case of an initial solution at a pH that is too high).

Subsequently, and during the introduction of the solution containing the rare-earth metal chloride(s), the pH of the precipitation medium gradually decreases; thus, according to one of the essential characteristics of the method according to the invention, for the purpose of maintaining the pH of the precipitation medium at the desired constant working value, which should be less than 2 and preferably between 1 and 2, a basic compound is simultaneously introduced into this medium.

According to another characteristic of the method of the invention, the basic compound which is used, either to bring the initial pH of the second solution containing the phosphate ions to a value of less than 2 or to control the pH during the precipitation, is at least partly sodium hydroxide. The term “at least partly” is intended to mean that it is possible to use a mixture of basic compounds, at least one of which is sodium hydroxide. The other basic compound can, for example, be aqueous ammonia. According to one preferred embodiment, a basic compound which is solely sodium hydroxide is used, and according to another even more preferred embodiment, sodium hydroxide is used alone and for both the abovementioned operations, i.e. both for bringing the pH of the second solution to the suitable value and for controlling the pH of the precipitation. In these two preferred embodiments, the discharge of nitrogenous products which could be introduced by a basic compound such as aqueous ammonia is reduced or eliminated.

At the end of the precipitation step, a phosphate of a rare-earth metal (Ln), optionally with other elements added thereto, is directly obtained. The overall concentration of rare-earth metals in the final precipitation medium is then advantageously greater than 0.25 mol/liter.

At the end of the precipitation, it is possible to optionally carry out maturing by keeping the reaction medium previously obtained at a temperature within the same temperature range as that at which the precipitation took place and for a period of time which can be between a quarter of an hour and one hour, for example.

The phosphate precipitate can be recovered by any means known per se, in particular by simple filtration. This is because, under the conditions of the method according to the invention, a rare-earth metal phosphate which is nongelatinous and which can easily be filtered off is precipitated.

The product recovered is then washed, for example with water, and then dried.

The product can then be subjected to a heat treatment or calcination. The temperature and the duration of this calcination depend on the crystalline structure desired for the phosphate which will be derived therefrom. Generally, a calcination temperature up to approximately 400° C. makes it possible to obtain a product with a rhabdophane structure, which structure is also that exhibited by the noncalcined product resulting from the precipitation. For the mixed rhabdophane/monazite structure, the calcination temperature is generally at least approximately 400° C. and it can range up to a temperature below 600° C.; it can thus be between 400° C. and 500° C.

The higher the temperature, generally the shorter the calcination time. By way purely of example, this time can be between 1 and 3 hours.

The heat treatment is generally carried out under air.

The higher the calcination temperature, the larger the crystallite size of the phosphate.

According to another important characteristic of the invention, the product resulting from the calcination or else resulting from the precipitation when there is no heat treatment is then redispersed in hot water.

This redispersion is carried out by introducing the solid product into the water with stirring. The resulting suspension is kept stirring for a period which may be between approximately 1 and 6 hours, more particularly between approximately 1 and 3 hours.

The temperature of the water can be at least 30° C., more particularly at least 60° C., and it can be between approximately 30° C. and 90° C., preferably between 60° C. and 90° C., under atmospheric pressure. It is possible to carry out this operation under pressure, for example in an autoclave, at a temperature which can then be between 100° C. and 200° C., more particularly between 100° C. and 150° C.

In a final step, the solid is separated from the liquid medium by any means known per se, for example by simple filtration. It is possible to optionally repeat, one or more times, the redispersion step under the conditions described above, optionally at a temperature different than that at which the first redispersion was carried out.

The separated product can be washed, in particular with water, and can be dried.

The rare-earth metal (Ln) phosphate with a rhabdophane or rhabdophane/monazite structure of the invention, having the required sodium contents, is thus obtained.

The method for preparing the rare-earth metal (Ln) phosphates according to the second embodiment of the invention, i.e. with a crystalline structure of monazite type, is very close to that which has just been described. It differs therefrom only by virtue of the fact that the product resulting from the precipitation is calcined at a temperature of at least 600° C. What was described above for the preceding steps in the method for preparing the phosphates of the first embodiment therefore applies likewise here for the method for preparing the phosphates of the second embodiment.

The heat treatment or calcination can be carried out more particularly at a temperature of between 800 and 900° C.

Here again, the higher the calcination temperature, the larger the crystallite size of the phosphate.

The rest of the method, and in particular the step of redispersing in water, is identical to that described above for the phosphates according to the first embodiment.

### Method for Preparing the Phosphors

The phosphors of the invention are obtained by calcination, at a temperature of at least 1000° C., of a phosphate or precursor according to the two embodiments as described above or of a phosphate or precursor obtained by means of the methods which were also described above. This temperature can be between approximately 1000° C. and 1300° C.

By means of this treatment, the phosphates or precursors are converted into efficient phosphors.

The calcination can be carried out under air, under an inert gas, but also and preferably under a reducing atmosphere (H₂, N₂/H₂ or Ar/H₂, for example) in order, in the last case, to convert all the Ce and Tb entities to their oxidation state (+III).

In a known manner, the calcination can be carried out in the presence of a flux or fluxing agent, for instance lithium fluoride, lithium tetraborate, lithium chloride, lithium carbonate, lithium phosphate, potassium chloride, ammonium chloride, boron oxide and boric acid, and ammonium phosphates, and also mixtures thereof.

In the case of the use of a flux, a phosphor is obtained which has luminescence properties which, generally, are at least equivalent to those of the known phosphors. The most important advantage of the invention here is that the phosphors originate from precursors which themselves result from a method which discharges fewer nitrogenous products than the known methods, or none at all.

It is also possible to carry out the calcination in the absence of any flux, and therefore without prior mixing of the fluxing agent with the phosphate, and thereby contributing to reducing the level of impurities present in the phosphor. Furthermore, the use of products which may contain nitrogen, or which must be used within strict safety standards given their possible toxicity, which is the case of a large number of the fluxing agents mentioned above, is thus avoided.

Still in the case of calcination without flux, it is noted, and this is a significant advantage of the invention, that the precursors of the invention make it possible to obtain phosphors of which the luminescence properties are at least equivalent to those of the phosphors obtained from prior art precursors.

After treatment, the particles are advantageously washed, so as to obtain a phosphor which is as pure as possible and in a deagglomerated state or a low-agglomeration state. In the latter case, it is possible to deagglomerate the phosphor by subjecting it to a deagglomeration treatment under mild conditions.

The phosphors of the invention have intense luminescence properties for electromagnetic excitations corresponding to the various absorption fields of the product.

Thus, the phosphors based on cerium and terbium of the invention may be used in lighting or display systems having an excitation source in the UV range (200-280 nm), for example around 254 nm. In particular, note will be made of mercury vapor trichromatic lamps, lamps for backlighting of liquid crystal systems, in tubular or flat form (LCD backlighting). They have a high brightness under UV excitation, and an absence of luminescence loss following a thermal post-treatment. Their luminescence is, in particular, stable under UV at relatively high temperatures (100-300° C.).

The phosphors based on terbium and lanthanum or on lanthanum, cerium and terbium of the invention are also good candidates as green phosphors for VUV (or “plasma”) excitation systems, such as, for example, plasma screens and trichromatic lamps without mercury, in particular xenon excitation lamps (tubular or flat). The phosphors of the invention have a strong green emission under VUV excitation (for example, around 147 nm and 172 nm). The phosphors are stable under VUV excitation.

The phosphors of the invention can also be used as green phosphors in devices for excitation by light-emitting diode. They may in particular be used in systems that can be excited in the near UV.

They may also be used in UV excitation marking systems.

The phosphors of the invention may be used in the lamp and screen systems by means of well-known techniques, for example by screen printing, spraying, electrophoresis or sedimentation.

They may also be dispersed in organic matrices (for example, plastic matrices or matrices of polymers that are transparent under UV, etc.), mineral matrices (for example silica matrices) or mixed organo-mineral matrices.

According to another aspect, the invention also relates to the luminescent devices of the abovementioned type, comprising, as green luminescence source, the phosphors as described above or the phosphors obtained using methods also described above.

Examples will now be given.

In these examples, the sodium content is determined, as indicated above, by means of two measuring techniques. For the X-ray fluorescence technique, it is a semi-quantitative analysis carried out on the powder of the product as it is. The instrument used is a MagiX PRO PW 2540 X-ray fluorescence spectrometer from PANalytical. The ICP-AES (or OES) technique is carried out by performing a quantitative assay by metered additions with an Ultima instrument from Jobin Yvon. The samples are subjected beforehand to mineralization (or digestion) in a nitric-perchloric medium assisted by microwaves in closed reactors (MARS system—CEM).

The luminescence yield is measured on the products in powder form by comparing the areas under the curve of the emission spectrum between 380 nm and 750 nm recorded with a spectrofluorimeter under excitation at 254 nm and assigning a value of 100% to the area obtained for the comparative product.

### COMPARATIVE EXAMPLE 1

This example concerns the preparation of a phosphate of lanthanum, cerium and terbium according to the prior art.

Added, in one hour, to 1 l of a solution containing 1.73 mol/l of analytical grade phosphoric acid H₃PO₄, previously brought to pH 1.6 by adding aqueous ammonia and brought to 60° C., is 1 l of a solution of rare-earth metal nitrates of 4N purity, having an overall concentration of 1.5 mol/l and which can be broken down as follows: 0.66 mol/l of lanthanum nitrate, 0.65 mol/l of cerium nitrate and 0.20 mol/l of terbium nitrate. The pH during the precipitation is regulated at 1.6 by addition of aqueous ammonia.

At the end of the precipitation step, the mixture is maintained at 60° C. for a further 1 h. The resulting precipitate is then recovered by filtration, washed with water and then dried at 60° C. under air, and then subjected to heat treatment for 2 h at 840° C. under air. At the end of this step, a precursor having the composition (La_{0.44}Ce_{0.43}Tb_{0.13})PO₄ is obtained.

### EXAMPLE 2

This example concerns the preparation of a phosphate of lanthanum, cerium and terbium according to the invention.

Added, in one hour, to 1 l of a solution containing 1.5 mol/l of analytical grade phosphoric acid H₃PO₄, previously brought to pH 1.6 by adding sodium hydroxide NaOH and brought to 60° C., is 1 l of a solution of rare-earth metal chlorides of 4N purity, having an overall concentration of 1.3 mol/l and which can be broken down as follows: 0.57 mol/l of lanthanum chloride, 0.56 mol/l of cerium chloride and 0.17 mol/l of terbium chloride. The pH during the precipitation is regulated at 1.6 by addition of sodium hydroxide.

At the end of the precipitation step, the mixture is maintained at 60° C. for a further 15 minutes. The resulting precipitate is then recovered by filtration, washed with water and then dried at 60° C. under air, and then subjected to a heat treatment for 2 h at 840° C. under air. At the end of the calcination, the product obtained is redispersed in hot water at 80° C. for 3 h, then washed and filtered, and finally dried. At the end of this step, a precursor having the composition (La_{0.44}Ce_{0.43}Tb_{0.13})PO₄ is obtained.

The characteristics of the products of examples 1 and 2 are given in table 1 below.

TABLE 1

| Example | Comparative 1 | | Invention 2 | |
|---|---|---|---|---|
| Crystalline characteristics | | | | |
| Phase | Monazite | | Monazite | |
| Crystallinity (intensity of | 31000 | | 46000 | |
| the main peak, in number of | | | | |
| counts) | | | | |
| Sodium content | 0 | | 2200 | ppm |
| Crystallite size (012) | 49 | nm | 102 | nm |
| Particle size | | | | |
| Ø₅₀ | 4.7 | μm | 4.5 | μm |

| | | |
|---|---|---|
| I dispersion index | 0.5 | 0.5 |

The precursor phosphate of the invention is better crystallized than that of the prior art while at the same time retaining similar particle size characteristics.

### COMPARATIVE EXAMPLE 3

This example concerns the preparation of a phosphor according to the prior art, obtained from the phosphate of example 1.

The precursor phosphate obtained in example 1 is re-treated under a reducing atmosphere (Ar/H₂) for 2 h at 1000° C. The calcination product obtained is then washed in hot water at 80° C. for 3 h, and then filtered and dried.

### EXAMPLE 4

This example concerns the preparation of a phosphor according to the invention, obtained from the phosphate of example 2.

The precursor phosphate obtained in example 2 is re-treated under the same conditions as those of example 3.

The characteristics of the products of examples 3 and 4 are given in table 2 below.

TABLE 2

| Example | Comparative 3 | | Invention 4 | |
|---|---|---|---|---|
| Crystalline characteristics | | | | |
| Phase | Monazite | | Monazite | |
| Crystallinity (intensity of | 56000 | | 73000 | |
| the main peak, in number of | | | | |
| counts) | | | | |
| Sodium content | 0 | | 330 | ppm |
| Coherence length in the | 120 | nm | 305 | nm |
| plane (012) | | | | |
| Particle size | | | | |
| Ø₅₀ | 4.5 | μm | 5.0 | μm |

| | | |
|---|---|---|
| I dispersion index | 0.5 | 0.5 |
| Luminescence yield | 100% | 100% |

The luminescence yield of the phosphor of the invention is given relative to the comparative phosphor 3.

The phosphor of the invention therefore has an improved crystallinity and a luminescence yield equivalent to the phosphor obtained in the comparative example, while at the same time retaining the same particle size quality.

1. A rare-earth metal (Ln) phosphate, comprising Ln, wherein Ln represents either: (1) at least one rare-earth metal selected from the group consisting of cerium and terbium, or lanthanum in combination with at least one of the abovementioned two rare-earth metals, and wherein the phosphate has a crystalline structure, either of rhabdophane type or of mixed rhabdophane/monazite type, and comprises sodium, with a sodium content of at most 6000 ppm.

2. The phosphate as claimed in claim 1, wherein the sodium content is at most 5000 ppm.

3. The phosphate as claimed in claim 1, wherein the phosphate is comprised of crystallites having a size, measured in a plane (012), of at least 35 nm.

4. A rare-earth metal (Ln) phosphate, comprising Ln, wherein Ln represents either: (1) at least one rare-earth metal selected from the group consisting of cerium and terbium, or (2) lanthanum in combination with at least one of the abovementioned two rare-earth metals, and wherein the phosphate has a crystalline structure of monazite type and comprises sodium, with a sodium content of at most 4000 ppm.

5. The phosphate as claimed in claim 3, wherein the sodium content is at most 3000 ppm.

6. The phosphate as claimed in claim 4, wherein the phosphate is comprised of crystallites having a size, measured in a plane (012), of at least 40 nm.

7. The phosphate as claimed in claim 1, wherein the sodium content is at least 300 ppm.

8. The phosphate as claimed in claim 1, wherein the phosphate comprises a product having the following general formula (I):
LaₓCe_{y}Tb_{z}PO₄ (1)
in which the sum x+y+z is equal to 1 and at least one of y and of z is other than 0, it being possible for x to be more particularly between 0.4 and 0.95.

9. A phosphor comprising a rare-earth metal (Ln) phosphate, wherein Ln represents either: (1) at least one rare-earth metal selected from the group consisting of cerium and terbium, or (2) lanthanum in combination with at least one of the abovementioned two rare-earth metals, and wherein the phosphate has a crystalline structure of monazite type and comprises sodium, with a sodium content of at most 350 ppm.

10. The phosphor as claimed in claim 9, wherein the phosphate is comprised of particles having a coherence length, measured in a plane (012), of at least 250 nm.

11. The phosphor as claimed in claim 9, wherein the sodium content is at least 10 ppm.

12. A method for preparing a phosphate as claimed in claim 1, the method comprising the following steps:
continuously introducing a first solution comprising rare-earth metal (Ln) chlorides into a second solution comprising phosphate ions and having an initial pH of less than 2;
during introduction of the first solution into the second, controlling the pH of the resulting medium at a constant value of less than 2, by virtue of which a precipitate is obtained, wherein the placing of the second solution at a pH of less than 2 for the first step or the controlling of the pH for the second step, or both, are carried out at least partly with sodium hydroxide;
reovering a resulting precipitate and, optionally, calcining the precipitate at a temperature below 600° C.; and
redispersing a product obtained in hot water and then separating it from the liquid medium.

13. A method for preparing a phosphate as claimed in claim 4, the method comprising the following steps:
continuously introducing a first solution comprising rare-earth metal (Ln) chlorides into a second solution comprising phosphate ions and having an initial pH of less than 2;
during introduction of the first solution into the second, controlling the pH of a resulting medium at a constant value of less than 2, by virtue of which a precipitate is obtained, wherein the placing of the second solution at a pH of less than 2 for the first step or the controlling of the pH for the second step, or both, are carried out at least partly with sodium hydroxide;
recovering a resulting precipitate and calcining the precipitate at a temperature of at least 600° C.; and
redispersing a product obtained in hot water and then separating it from the liquid medium.

14. A method for preparing a phosphor as claimed in claim 9, the method comprising calcining the phosphate at a temperature of at least 1000° C.

15. The method as claimed in claim 14, wherein the calcination is carried out under a reducing atmosphere.

16. A device for: a plasma system, a mercury vapor lamp, a lamp for backlighting liquid crystal systems, a trichromatic lamp without mercury, excitation by light-emitting diode or a UV excitation marking system the device comprising or manufactured using a phosphor as claimed in claim 9.

17. The phosphate as claimed in claim 6, wherein the size of the crystallites, measured in the plane (012), is at least 100 nm.

18. The phosphate as claimed in claim 7, wherein the sodium content is at least 1200 ppm.

19. The phosphor as claimed in claim 11, wherein the sodium content is at least 50 ppm.
